(19) United States
(12) Patent Application Publication
(10) Pub. No.: US 2005/0250512 A1
(43) Pub. Date: Nov. 10, 2005

(54) Wireless communication system and method for configuring cells with enhanced uplink services

(75) Inventors: Guodong Zhang, Farmingdale, NY (US); Stephen E. Terry, Northport, NY (US); James M. Miller, Verona, NJ (US); Stephen G. Dick, Nesconset, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/116,073

(22) Filed: Apr. 27, 2005

Related U.S. Application Data
(60) Provisional application No. 60/569,027, filed on May 7, 2004.

(51) Int. Cl. H04Q 7/20

(52) U.S. Cl. 455/453; 455/428

(57) ABSTRACT

A wireless multi-cell communication system and a method for configuring a cell for enhanced uplink (EU) services. The wireless communication system includes at least one wireless transmit/receive unit (WTRU), at least one Node-B and a radio network controller (RNC). The RNC configures EU services for the WTRU and the Node-B in at least one cell of the system. At least one of the WTRU and the Node-B report EU traffic statistics and EU performance statistics to the RNC. The RNC adjusts the configuration of the EU services for the WTRU and the Node-B in the at least one cell in accordance with the received EU traffic statistics and the EU performance statistics.

### CROSS REFERENCE TO RELATED APPLICATIONS

This application claims the benefit of U.S. Provisional Application No. 60/569,027 filed May 7, 2004, which is incorporated by reference as if fully set forth. This application is also related to U.S. patent application Ser. No. ______, entitled “Wireless Communication Method and System for Configuring Radio Access Bearers for Enhanced Uplink Services,” filed on even date herewith, which is incorporated by reference as if fully set forth.

### FIELD OF INVENTION

The present invention is related to a wireless multi-cell communication system including at least one wireless transmit/receive unit (WTRU), at least one Node-B and a radio network controller (RNC). More particularly, the present invention is a method and system for configuring and operating a particular system cell with enhanced uplink (EU) services.

### BACKGROUND

Methods for improving uplink (UL) coverage, throughput and transmission latency are currently being investigated in the 3rd generation partnership project (3GPP). In order to achieve these goals, control, (i.e., scheduling and assigning), of UL resources, (i.e., physical channels), will be moved from the RNC to the Node-B.

The Node-B can make more efficient decisions and manage UL radio resources on a short-term basis better than the RNC. However, the RNC should retain coarse overall control of the cell with EU services so that the RNC can perform functions such as call admission control and congestion control.

### SUMMARY

The present invention is a method and system for configuring EU services in a wireless multi-cell communication system. The wireless communication system includes at least one WTRU, at least one Node-B and an RNC. The RNC configures EU services for the WTRU and the Node-B in at least one cell of the system. At least one of the WTRU and the Node-B report EU traffic statistics and EU performance statistics to the RNC. The RNC adjusts the configuration of the EU services for the WTRU and the Node-B in at least one cell in accordance with the received EU traffic statistics and the EU performance statistics.

### BRIEF DESCRIPTION OF THE DRAWINGS

A more detailed understanding of the invention may be had from the following description of a preferred embodiment, given by way of example and to be understood in conjunction with the accompanying drawing wherein:

FIG. 1 is a block diagram of a wireless communication system configured in accordance with the present invention; and

FIG. 2 is a signal diagram of a process implemented by the system of FIG. 1 for configuring EU services.

### DETAILED DESCRIPTION OF THE PREFERRED EMBODIMENTS

Hereafter, the terminology “WTRU” includes but is not limited to a user equipment (UE), a mobile station, a fixed or mobile subscriber unit, a pager, or any other type of device capable of operating in a wireless environment. When referred to hereafter, the terminology “Node-B” includes but is not limited to a base station, a site controller, an access point or any other type of interfacing device in a wireless environment.

The features of the present invention may be incorporated into an integrated circuit (IC) or be configured in a circuit comprising a multitude of interconnecting components.

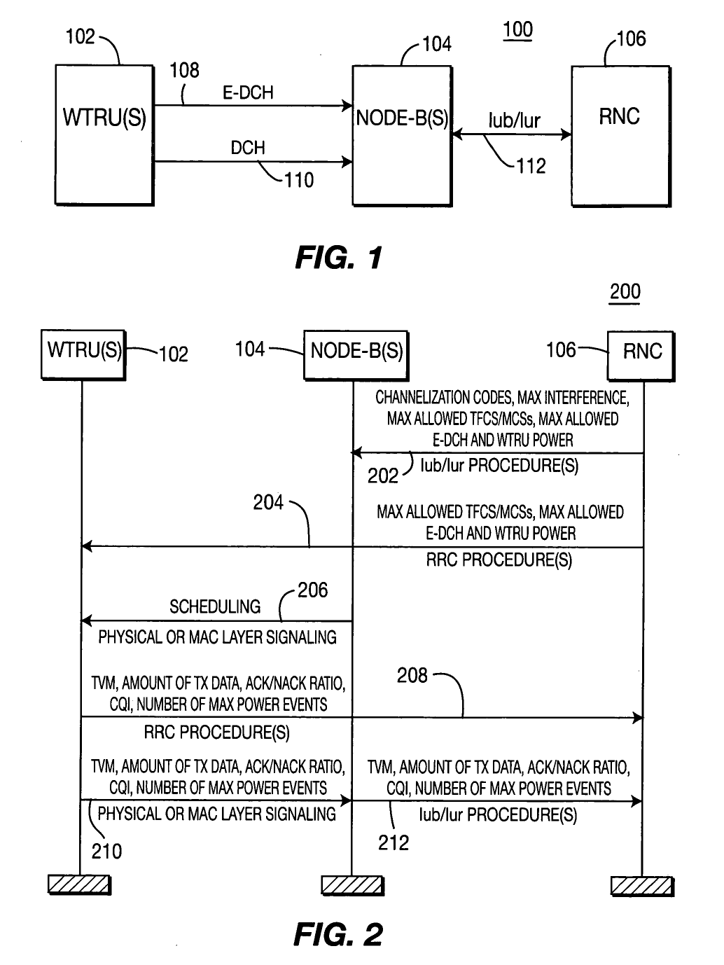

FIG. 1 is a block diagram of a wireless multi-cell communication system 100 in accordance with the present invention. The system 100 comprises at least one WTRU 102, at least one Node-B 104 and an RNC 106. An enhanced dedicated channel (E-DCH) 108, (along with associated signaling channels), is established for EU transmissions between the WTRU 102 and the Node-B 104 in addition to a regular dedicated channel (DCH) 110. Of course, those of skill in the art would understand that FIG. 1 does not depict all of the signaling, such as any downlink (DL) channels, between the WTRU 102 and the Node-B 104 that is not specifically relevant to the present invention.

The RNC 106 controls overall EU operation via an Iub/Iur interface 112 by configuring parameters for EU transmissions for the Node-B 104 and the WTRU 102, which will be explained in detail hereinafter. The RNC 106 performs cell level or system level functions such as call admission control and congestion control without closely monitoring the Node-B 104 as it schedules EU transmissions over the E-DCH, (i.e., uplink) on a per TTI basis.

The present invention provides a solution for the RNC 106 to keep coarse overall control of the cell with EU services. With proper setting for EU services, the RNC 106 can keep overall control of the cells, and the cell resources will be efficiently utilized for both regular DCHs 110 and E-DCHs 108.

The RNC 106 configures initial parameters for EU services when the system is initialized. The configuration for EU services includes limits of physical resources, (i.e., channelization codes), that can be used for EU transmissions and limits of interference caused by EU transmissions at any time in each cell.

The RNC 106 configures the channelization codes that can be used for EU transmissions scheduled by the Node-B 104. Initially, the number of channelization codes that can be used for EU transmissions is determined by considering the expected load of regular DCH traffic and the expected load of E-DCH traffic, or the like.

The expected load of regular DCH traffic in the UL is determined by a required energy per bit to noise ratio, a data rate and an activity factor. The expected load of E-DCH traffic is determined by possible modulation and coding schemes (MCS) and the probability that each MCS is applied, a required energy per bit to noise ratio of each MCS, possible transport format combinations (TFCs) and the probability that each TFC may be applied, and an activity factor, etc.

Once the number of channelization codes that can be used for EU transmissions is determined for each cell, the RNC 106 sets a part of a code tree, which contains the determined number of channelization codes, in the cell for the EU services and transmits it to at least one Node-B 104. In order to transmit the allocation from the RNC 106 to the Node-B 104, a new Iub/Iur procedure is implemented or modification of existing Iub/Iur procedures is provided between the Node-B 104 and the RNC 106.

The interference caused by EU transmissions on a per TTI basis is under the control of the Node-B 104 rather than the RNC 106, while the interference caused by regular DCH traffic is under the control of the RNC 106. However, it is critical for the RNC 106 to limit the interference of each system cell caused by the EU transmissions. Therefore, the RNC 106 should perform cell level or system level functions such as call admission control and congestion control and should constrain the Node-B 104 as it schedules EU transmissions over the E-DCH 108 on a per TTI basis.

Initially, the maximum allowed interference caused by EU transmissions is determined by considering expected load of regular DCH traffic in the UL, expected load of E-DCH traffic, and maximum allowed interference for all traffic in the UL in the cell and in neighboring cells. The RNC 106 configures the Node-B 104 with the maximum allowed EU interference limit.

The Node-B 104 performs scheduling of EU transmissions on a per TTI basis according to the limits set by the RNC 106. The channelization codes used by any scheduled EU transmissions must belong to channelization codes assigned by the RNC 106. The transmit power allocated by Node-B 104 scheduling must not exceed the maximum allowed EU interference limit set by the RNC. The RNC 106 forwards some configuration/reconfiguration of EU services in the WTRU 102 to the Node-B 104. The configuration of the WTRU may include, but is not limited to, at least one of an allowed transport format combination set (TFCS) for E-DCH of the WTRU 102, allowed MCSs for E-DCH of the WTRU 102, a maximum allowed E-DCH transmit power of the WTRU 102, and a maximum allowed WTRU transmit power.

If TFCs and MCSs are explicitly identified in the schedule sent by the Node-B 104, the allowed TFCs and MCSs must belong to the TFCS and MCSs allowed by the RNC 106. The transmission of the channel allocation information is by either physical layer or MAC layer signaling. The Node-B 104 may schedule EU transmissions for several users at the same time. However, the total interference caused by the EU transmissions at any TTI is required to be within the interference limit for all affected cells, as determined by the RNC 106. The Node-B 104 may use explicit or implicit TFCS management to control cell interference.

Once the WTRU 102 starts to operate on the E-DCH 108, EU traffic statistics and EU performance statistics are generated and reported to the RNC 106 by at least one of the WTRU 102 and the Node-B 104.

The EU traffic statistics may be a traffic volume measurement (TVM) of EU data or volume of successfully or unsuccessfully transmitted EU data. The EU performance statistics may include, but are not limited to, at least one of resource utilization per cell and/or per WTRU, an acknowledge/non-acknowledge (ACK/NACK) ratio per cell/resource and/or per WTRU, (or average number of transmissions that failed in the MAC layer), average channel quality indicator (CQI) results per cell/resource and/or per WTRU, (or best or worst CQI results), and the number of events that WTRU maximum transmit power is reached or EU maximum transmit power of the WTRU is reached.

The reporting can be periodic or threshold based. The periods or thresholds of reporting are set by the RNC 106 and are also design parameters.

EU traffic and performance statistics may be reported by the WTRU 102 to the RNC 106 via radio resource control (RRC) procedures. In this case, the RNC 106 aggregates the EU traffic statistics of WTRUs 102 in the same cell to get the total EU traffic statistics in each cell. The RNC 106 also computes the average of reported performance of all WTRUs 102 in the same cell to get the average performance statistics for WTRUs 102 in each cell.

Alternatively, EU traffic and performance statistics may be reported by the Node-B 104. In this case, the EU traffic and performance statistics are generated by the WTRU 102 and reported to the Node-B 104 through a physical or MAC layer signaling, which can be either new signaling or modified existing signaling. The EU traffic and performance statistics are then forwarded to the RNC 106 via new or modified Iub/Iur procedures.

Other measurement data known only to the Node-B 104 may also be transmitted to the RNC 106 to allow for the RNC 106 to control EU resources. This may include, but is not limited to, at least one of a received code power on EU assigned codes reported either on a WTRU or cell basis, interference received based on EU assigned codes, or an ACK/NACK ratio as perceived by the Node-B 104.

In addition to EU traffic and performance statistics and measurement reports sent to the RNC 106, the adjustment of the configuration of EU services may also depend on some information collected by the RNC 106 itself, which includes traffic and performance statistics of a regular DCH and some EU performance statistics.

Upon receiving of reported EU traffic and performance statistics and measurement reports from the WTRU 102 and/or the Node-B 104, the RNC 106 adjusts configuration of EU services in the Node-B 104 and the WTRU 102.

FIG. 2 is a signal diagram of a process 200 implemented by the system 100 for signaling between the WTRU 102, the Node-B 104 and the RNC 106 for configuring and reconfiguring cells with EU services in accordance with the present invention. The RNC 106 sends an initial configuration, (such as channelization codes, maximum interference, maximum allowed TFCS/MCSs, maximum allowed E-DCH and WTRU power, or the like), to the Node-B 104 at the initiation of the system 100 through the Iub/Iur 112 interface (step 202). The RNC 106 also sends WTRU configuration information for EU services, (e.g., maximum allowed TFCS/MCSs and maximum allowed E-DCH and WTRU power, or the like), through RRC messages to the WTRU 102 (step 204).

EU scheduling is performed by the Node-B 104 within the limits of the configuration set by the RNC 106, and transmitted to the WTRU 102 by physical or MAC layer signaling (step 206). The WTRU 102 reports EU traffic and performance statistics, (such as TVM, amount of transmit data, an ACK/NACK ratio, a CQI, and the number of maximum power events, etc.), to the RNC 106 through RRC messages (step 208), or to the Node-B 104 by physical or MAC layer signaling (step 210) to be forwarded to the RNC 106 by Iub/Iur procedures (step 212). The RNC 106 reconfigures the cells with EU services in accordance with the reported statistics (step 202).

Although the features and elements of the present invention are described in the preferred embodiments in particular combinations, each feature or element can be used alone without the other features and elements of the preferred embodiments or in various combinations with or without other features and elements of the present invention.

1. In a wireless multi-cell communication system comprising at least one wireless transmit/receive unit (WTRU), at least one Node-B and a radio network controller (RNC), a method for configuring at least one cell of the system with enhanced uplink (EU) services, the method comprising:
(a) the RNC configuring EU services for a WTRU and a Node-B in at least one cell of the system;
(b) at least one of the WTRU and the Node-B reporting EU traffic statistics and EU performance statistics to the RNC; and
(c) the RNC adjusting the configuration of at least one cell of the system with EU services for the WTRU and the Node-B in accordance with the reported EU traffic statistics and EU performance statistics.

2. The method of claim 1 wherein the initial configuration for the Node-B includes a limit on channelization codes for EU transmissions.

3. The method of claim 2 wherein the limit on channelization codes is determined by considering at least one of an expected load of regular dedicated channel (DCH) traffic in uplink and an expected load of EU traffic.

4. The method of claim 3 wherein the expected load of DCH traffic is determined by considering at least one of a required energy per bit to noise ratio, a data rate and an activity factor.

5. The method of claim 3 wherein the expected load of EU traffic is determined by considering at least on of possible modulation and coding schemes (MCS), the probability that each MCS is applied, a required energy per bit to noise ratio of each MCS, possible transport format combinations (TFCs), the probability that each TFC may be applied and an activity factor.

6. The method of claim 1 wherein the initial configuration for the Node-B includes a limit on interference caused by EU transmissions.

7. The method of claim 6 wherein the limit on interference caused by EU transmissions is determined by considering at least one of an expected load of regular dedicated channel (DCH) traffic in uplink and an expected load of EU traffic.

8. The method of claim 7 wherein the expected load of DCH traffic is determined by considering at least one of a required energy per bit to noise ratio, a data rate and an activity factor.

9. The method of claim 7 wherein the expected load of EU traffic is determined by considering at least one of possible modulation and coding schemes (MCS), the probability that each MCS is applied, a required energy per bit to noise ratio of each MCS, possible transport format combinations (TFCs), the probability that each TFC may be applied and an activity factor.

10. The method of claim 7 wherein maximum allowed interference in the uplink in a cell and neighboring cells is further considered in determining the limit on interference.

11. The method of claim 1 wherein the configuration of EU services for the WTRU includes at least one of an allowed transport format combination set (TFCS) for E-DCH of the WTRU, an allowed MCS for enhanced dedicated channel (E-DCH) of the WTRU, a maximum allowed E-DCH transmit power of the WTRU, and a maximum allowed WTRU transmit power.

12. The method of claim 11 wherein the configuration of EU services for the WTRU is also transmitted to the Node-B.

13. The method of claim 1 wherein the EU traffic statistics includes at least one of traffic volume measurement of EU data and volume of successfully or unsuccessfully transmitted EU data.

14. The method of claim 1 wherein the EU performance statistics includes at least one of resource utilization per cell, resource utilization per WTRU, an ACK/NACK ratio per cell, an ACK/NACK ratio per resource, an ACK/NACK ratio per WTRU, an average number of failed transmissions in a medium access control (MAC) layer, average channel quality indicator (CQI) results per cell, average CQI results per WTRU, best CQI results, worst CQI results, the number of events for which the WTRU maximum transmit power is reached, and the number of events for which the EU maximum transmit power is reached.

15. The method of claim 1 wherein the reporting of the statistics is periodic.

16. The method of claim 1 wherein the reporting of the statistics is triggered by a predetermined threshold test.

17. The method of claim 1 wherein the adjustment of the configuration further depends on information collected by the RNC including traffic and performance statistics on a regular dedicated channel (DCH) and other EU transmission statistics.

18. A wireless multi-cell communication system for controlling at least one cell of the system to support enhanced uplink (EU) services, the system comprising:
(a) at least one wireless transmit/receive unit (WTRU) configured to transmit EU traffic statistics and EU performance statistics;
(b) at least one Node-B configured to transmit EU traffic statistics and EU performance statistics; and
(c) a radio network controller (RNC) for receiving the EU traffic statistics and EU performance statistics from at least one of the WTRU and the Node-B, and adjusting the configuration of at least one cell of the system with EU services for the WTRU and the Node-B in accordance with the received EU traffic statistics and EU performance statistics.

19. The system of claim 18 wherein the initial configuration for the Node-B includes a limit on channelization codes for EU transmissions.

20. The system of claim 19 wherein the limit on channelization codes is determined by considering at least one of an expected load of regular dedicated channel (DCH) traffic in uplink and an expected load of EU traffic.

21. The system of claim 20 wherein the expected load of DCH traffic is determined by considering at least one of a required energy per bit to noise ratio, a data rate and an activity factor.

22. The system of claim 20 wherein the expected load of EU traffic is determined by considering at least one of possible modulation and coding schemes (MCS), the probability that each MCS is applied, a required energy per bit to noise ratio of each MCS, possible transport format combinations (TFCs), the probability that each TFC may be applied and an activity factor.

23. The system of claim 18 wherein the initial configuration for the Node-B includes a limit on interference caused by EU transmissions.

24. The system of claim 23 wherein the limit on interference caused by EU transmissions is determined by considering at least one of an expected load of regular dedicated channel (DCH) traffic in uplink and an expected load of EU traffic.

25. The system of claim 24 wherein the expected load of DCH traffic is determined by considering at least one of a required energy per bit to noise ratio, a data rate and an activity factor.

26. The system of claim 24 wherein the expected load of EU traffic is determined by considering at least one of possible modulation and coding schemes (MCS), the probability that each MCS is applied, a required energy per bit to noise ratio of each MCS, possible transport format combinations (TFCs), the probability that each TFC may be applied and an activity factor.

27. The system of claim 18 wherein maximum allowed interference in the uplink in a cell and neighboring cells is further considered in determining the limit on interference.

28. The system of claim 18 wherein the configuration of EU services for the WTRU includes at least one of an allowed transport format combination set (TFCS) for E-DCH of the WTRU, an allowed MCS for enhanced dedicated channel (E-DCH) of the WTRU, a maximum allowed E-DCH transmit power of the WTRU, and a maximum allowed WTRU transmit power.

29. The system of claim 28 wherein the configuration of EU services for the WTRU is also transmitted to the Node-B.

30. The system of claim 18 wherein the EU traffic statistics include at least one of traffic volume measurement of EU data and volume of successfully or unsuccessfully transmitted EU data.

31. The system of claim 18 wherein the EU performance statistics include at least one of resource utilization per cell, resource utilization per WTRU, an ACK/NACK ratio per cell, an ACK/NACK ratio per resource, an ACK/NACK ratio per WTRU, an average number of failed transmissions in a medium access control (MAC) layer, average channel quality indicator (CQI) results per cell, average CQI results per WTRU, best CQI results, worst CQI results, the number of events for which the WTRU maximum transmit power is reached, and the number of events for which the EU maximum transmit power is reached.

32. The system of claim 18 wherein the transmission of the statistics is periodic.

33. The system of claim 18 wherein the transmission of the statistics is triggered by a predetermined threshold test.

34. The system of claim 18 wherein the adjustment of the configuration further depends on information collected by the RNC including traffic and performance statistics on a regular dedicated channel (DCH) and other EU transmission statistics.
